(19) United States
(12) Patent Application Publication
(10) Pub. No.: US 2003/0101597 A1
(43) Pub. Date: Jun. 5, 2003

(54) Knife assembly

(76) Inventor: Chen-Fen Chen, Nantou City (TW)

Correspondence Address: Connolly and Hutz, P.O. Box 2207, Wilmington, DE, 19899-2207, US

(21) Appl. No.: 10/005,939

(22) Filed: Dec. 4, 2001

(51) Int. Cl. B26B 3/00

(52) U.S. Cl. 30/342; 30/340

(57) ABSTRACT

A knife assembly comprises a blade, a rear extension and a handle. The blade and the rear extension lie in planes that are perpendicular to each other, forming a cross at a connecting place. When the knife is used for cutting, the resulted counterforce spreads over a horizontal area so as to reduce the pressure and avoid injuries of the hand and the elbow.

### BACKGROUND OF THE INVENTION

1. Field of the Invention

The present invention relates to a knife assembly.

2. Description of related art

A conventional knife comprises a blade, a rear extension and a handle. The blade and the rear extension form an integral body, lying in a common plane, with the rear extension being surrounded by the handle. Thus, during cutting, a counterforce is transmitted to the handle along the rear extension to act on the cutting hand linearly. Since the blade and the rear extension lie in a vertical plane, which is parallel to the counterforce and the counterforce is applied by stiff material, large pressure is exerted on the cutting hand, which implies a risk of injuries of hand and elbow. This is a problem for conventional knives that is hard to overcome. Conventional knives have been proved over the years and become convenient tools. In modern times, however, consumers have become safety-conscious, and safety now is considered as one of important factors for the economic value of a product. However, to protect the hand so far has not been counted in the design of knives.

### SUMMARY OF THE INVENTION

The present invention provides a knife assembly, having a blade and a rear extension, which lie in planes that are perpendicular to each other, forming a cross at a connecting place. The blade lies in a vertical plane, whereas the rear extension lies in a horizontal plane. When the knife is used for cutting, the resulted counterforce spreads over a horizontal area, reducing pressure and avoiding injuries of the hand. Furthermore, the rear extension responds flexibly to vertical force, further protecting the cutting hand.

It is the main object of the present invention to provide a knife assembly, which ensures reduced pressure on the hand during cutting so as to protect the holding hand and the elbow thereof.

### BRIEF DESCRIPTION OF THE DRAWINGS

The present invention can be more fully understood by reference to the following description and accompanying drawings, in which:

FIG. 1 is a perspective view of a knife assembly according to the present invention in a first embodiment thereof illustrating a detached handle part;

FIG. 1A is a side view of the handle part of the knife assembly shown in FIG. 1;

FIG. 2 is a perspective view of a knife assembly according to the present invention in a second embodiment thereof illustrating a detached handle part;.

FIG. 2A is a side view of the handle part of the knife assembly shown in FIG. 2;

FIG. 3 is a perspective view of a knife assembly of the present invention in a third embodiment thereof illustrating a detached handle part; and

FIG. 3A is a side view of the knife assembly shown in FIG. 3.

### DETAILED DESCRIPTION OF THE PREFERRED EMBODIMENTS

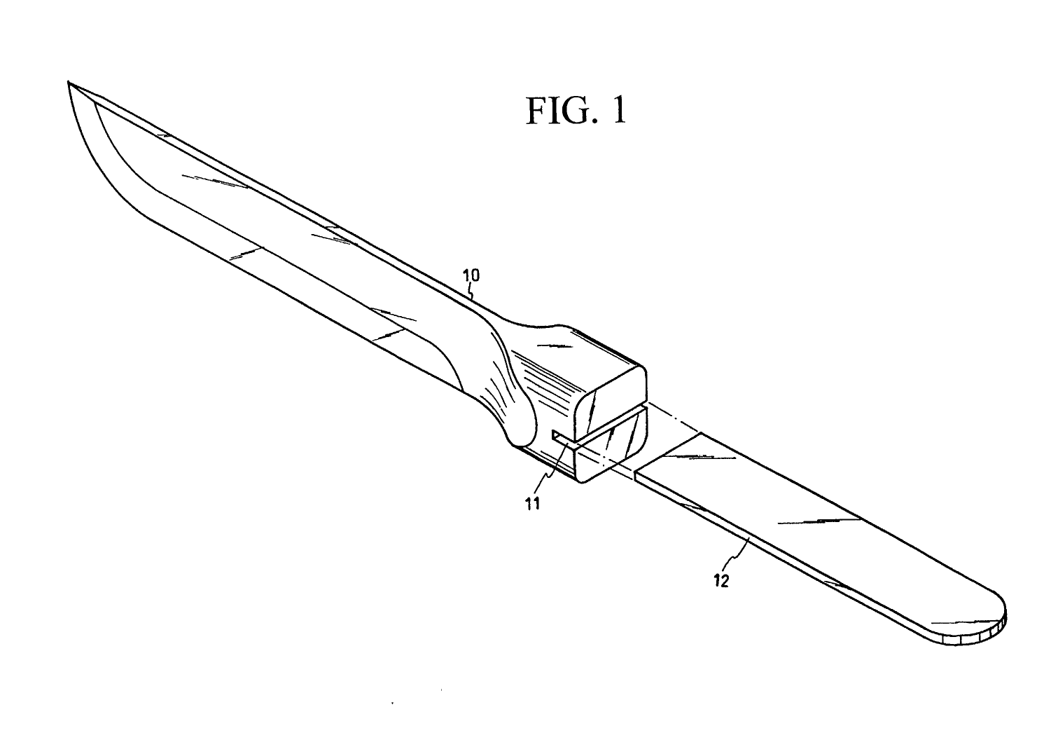

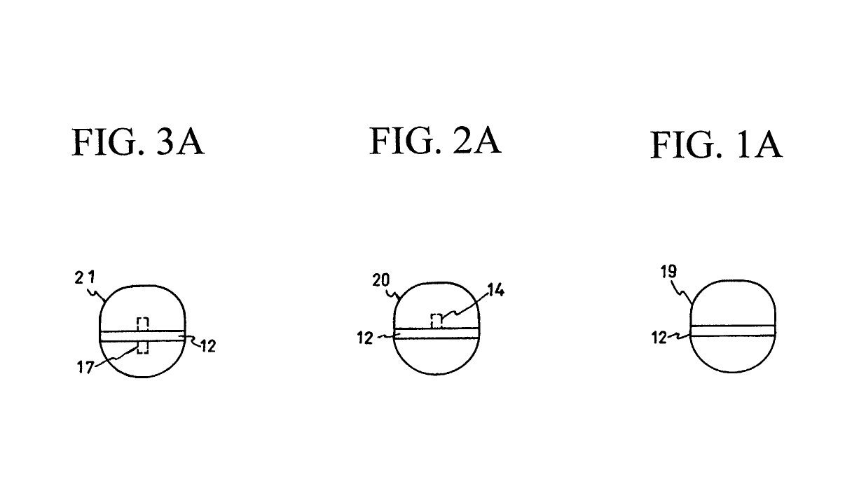

As shown in FIGS. 1 and 1A, the knife assembly of the present invention in a first embodiment mainly comprises a blade 10, a rear extension 12, and a handle 19. The blade 10, which defines a vertical plane, has a rear end, into which a horizontal groove 11 is cut. The rear extension 12 is shaped to fit into the handle 19 and inserted into the groove 11 and welded therewith. The handle 19 is glued to the rear extension 12 from above and below with the rear extension 12 being exposed horizontally, whereas in a conventional knife, the rear extension is exposed in the vertical direction. Alternatively, the rear extension 12 is completely enclosed by the handle 19, still being horizontally oriented, with vertical forces from the blade 10 being spread over the area of the rear extension 12. A hand, gripping the handle 19, is exposed to pressure uniformly distributed over the handle 19. In addition, the rear extension 12 is supple in response to vertical forces. Thus, during cutting, high pressure, as occurring in conventional knives, is avoided, and no injuries result.

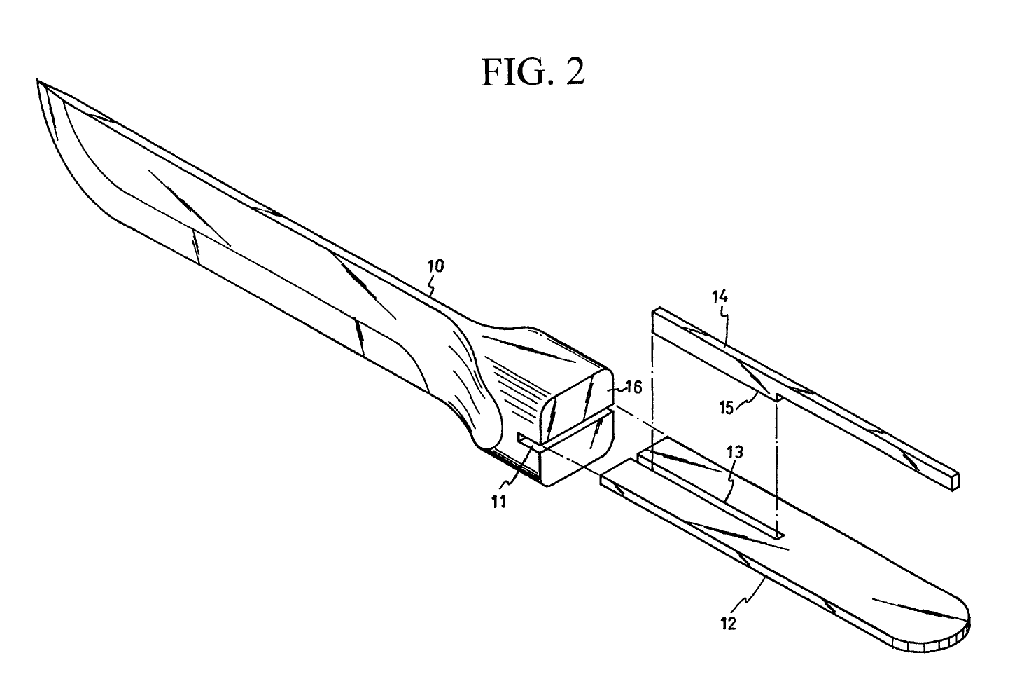

Referring to FIGS. 2 and 2A, the present invention in a second embodiment has a ridge 14. The ridge 14 has a forward end with a downward protrusion 15, with a corresponding slit 13 being cut into the rear extension 12. The protrusion 15 is inserted into the slit 13, and the rear extension 12, the ridge 14 and the blade 10 are welded together. The ridge 14 leans against the blade 10 at a contact surface 16. Therefore, during cutting, the rear extension 12 will be less bent under heavy use, e.g., cutting bones. Furthermore, the ridge 14 adds strength to the rear extension 12, while suitable flexibility thereof is maintained effectively to reduce hand injuries.

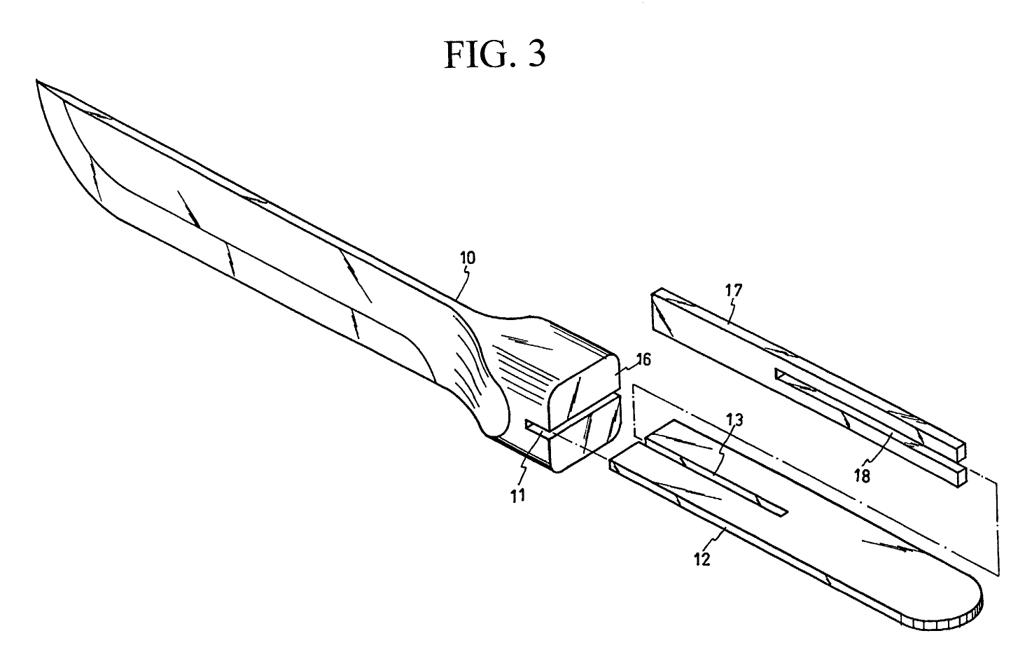

Referring to FIGS. 3 and 3A, for accommodating force distribution at mincing when the blade 10 is oriented the other way, the present invention in a third embodiment has a ridge 17, into which a slit 18 is cut, so that the ridge 17 fits into the slit 13 of the rear extension 12, with the ridge 17 sliding into the slit 13 and the rear extension 12 sliding into the slit 18. The rear extension 12 and the ridge 17 lean against the blade 10 at a contact surface 16. Thus, strength of the knife is maintained no matter which way the blade is used.

While the invention has been described with reference to preferred embodiments thereof, it is to be understood that modifications or variations may be easily made without departing from the spirit of this invention which is defined by the appended claims.

What is claimed is:

1. A knife assembly, comprising:
a blade, defining a vertical plane and having a rear end, into which a horizontal groove is cut, forming a cross with said blade;
a rear extension, being inserted into said groove; and
a handle, being put over said rear extension.

2. A knife assembly according to claim 1, wherein said rear extension has a slit, into which a protrusion of a ridge is inserted.

3. A knife assembly according to claim 2, wherein said ridge has a slit to mesh with the slit in the rear extension.
